(19) United States
(12) Patent Application Publication
(10) Pub. No.: US 2012/0178378 A1
(43) Pub. Date: Jul. 12, 2012

(54) WIRELESS TEST SERVER AND METHOD FOR TESTING ELECTRONIC DEVICES

(75) Inventor: MING-XIANG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/217,253

(22) Filed: Aug. 25, 2011

(30) Foreign Application Priority Data
Jan. 7, 2011 (CN) 201110002676.0

(51) Int. Cl. H04W 24/00

(52) U.S. Cl. 455/67.14

(57) ABSTRACT

In a method for testing electronic devices using a wireless test server, the server communicates with one or more workstations through a radio frequency unit. Each of the workstations includes a signal converter and a universal asynchronous receiver-transmitter (UART) adaptor. The server predefines an ID number for each of the workstations, and creates a wireless connection between the wireless test server and each of the workstations. The server generates a test command according to the ID number of the workstation, and converts the test commands into wireless signals and transmits each of the wireless signals to the UART adaptor corresponding to the workstation. Each of the signal converters converts the wireless signal received by the UART adaptor into a booting command. Each of the electronic devices performs a boot test operation according to the booting command, and generates a test result which is sent back to the test server.

### BACKGROUND

1. Technical Field

The embodiments of the present disclosure relate to wireless network test systems and methods, and more particularly to a wireless test server and method for testing electronic devices.

2. Description of Related Art

For manufacturers of electronic devices such as computers and servers, the quality of the electronic devices delivered from the factory needs to be strictly controlled. In order to assure the stability and reliability of the electronic devices, it is necessary to perform a series of tests before shipping. In traditional test methods, if one or more electronic devices needs to be tested in a network system, multiple electronic lines and data control lines may be used to connect the electronic devices to a host computer. However, the traditional test method is complicated, inefficient and costly, and the network system is difficult to maintain.

### BRIEF DESCRIPTION OF THE DRAWINGS

FIG. 1 is a block diagram of one embodiment of a wireless test system including a wireless test server.

FIG. 2 is a block diagram of one embodiment of the wireless test server of FIG. 1.

FIG. 3 is a flowchart of one embodiment of a method for testing electronic devices using the wireless test server of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

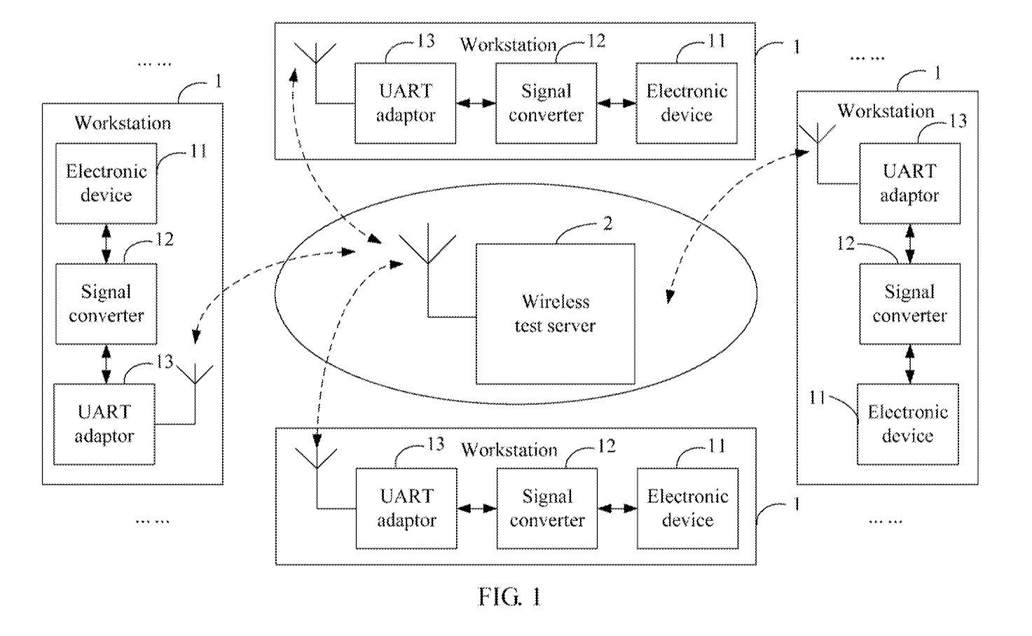

FIG. 1 is a block diagram of one embodiment of a wireless test system including a wireless test server 2. In the embodiment, the wireless test system further includes a plurality of workstations 1 that communicates with the wireless test server 2 through a wireless communication network, such as a radio frequency network, for example. Each of the workstations 1 includes at least one electronic device 11 to be tested, a signal converter 12, and a universal asynchronous receiver-transmitter (UART) adaptor 13. In each of the workstations 1, the electronic device 11 is connected to the signal converter 12, and the signal converter 12 is connected to the UART adaptor 13. Each of the UART adaptors 13 has an antenna, and creates a wireless connection between the corresponding workstation 1 and the wireless test server 2 through the antenna of the UART adaptor 13.

Each of the electronic devices 11 is installed with a power-on self-test (POST) program for testing the performance of the electronic device 11. When a test command is received from the wireless server 2, each of the electronic devices 11 executes the POST program to perform a boot test operation, and accordingly generates a test result indicating the performance of the electronic device 11. In one embodiment, the electronic devices 11 include, but are not limited to, computers, mobile phones, GPS devices, and MP3 and MP4 players.

The signal converter 12 converts a wireless test signal into a test command when the UART adaptor 13 receives the wireless test signal transmitted from the wireless test server 2, and sends the test command to the electronic device 11 to execute the POST program. The electronic device 11 generates a test result during performing the boot test. The signal converter 12 further converts the test result into a UART signal, and sends the UART signal to the UART adaptor 13.

The UART adaptor 13 receives the wireless test signal transmitted from the wireless test server 2, and transmits the UART signal to the wireless test server 2 when the UART signal is received from the signal converter 12. In one embodiment, the UART adaptor 13 may be a chipset that adapts to an international common network protocol, such as the IEEE 801.15.4 protocol or a ZigBee network protocol.

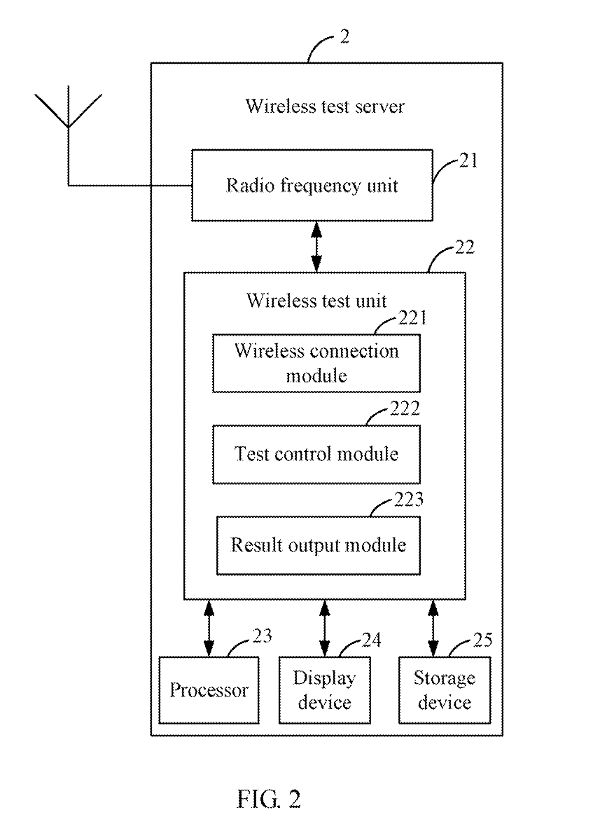

FIG. 2 is a block diagram of one embodiment of the wireless test server 2. In the embodiment, the wireless test server 2 includes a radio frequency unit 21, a wireless test unit 22, at least one processor 23, a display device 24, and a storage device 25. FIG. 2 illustrates only one example of the wireless test server 2, a wireless test server in another embodiment may include more or fewer components than illustrated, or may have a different configuration of the various components.

The wireless test unit 22 includes computerized instructions in the form of one or more programs that are executed by the at least one processor 23, and stored in the storage device 25. In one embodiment, the storage device 25 may be an internal storage system, such as a random access memory (RAM) for the temporary storage of information, and/or a read only memory (ROM) for the permanent storage of information. In some embodiments, the storage device 25 may also be an external storage system, such as an external hard disk, a storage card, or a data storage medium.

In one embodiment, the wireless test unit 22 may include a wireless connection module 221, a test control module 222, and a result output module 223. The modules 121-123 may comprise computerized code in the form of one or more programs that are stored in the storage device 25 and executed by the processor 23 to provide functions for implementing the modules. In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

The wireless connection module 221 is operable to predefine an ID number for each of the workstations 1, and create a wireless connection between each of the workstations 1 and the wireless test server 2. In one embodiment, the wireless connection module 221 controls the radio frequency unit 21 to connect to each of the UART adaptors 13 through the antenna of the UART adaptor 13. The radio frequency unit 21 identifies each of the UART adaptors 13 to create the wireless connection(s) according to the ID number of the workstation 1.

The test control module 222 is operable to generate a test command for testing each of the electronic devices 11 according to the ID number of the workstation 1, and convert the test command into a wireless signal for transmission to the UART adaptor 13 corresponding to the workstation 1.

When each of the UART adaptors 13 receives the wireless signal from the radio frequency unit 21, the signal converter 12 converts the wireless signal into a booting command, and commands the electronic device 11 to perform a boot test operation by executing the POST program of the electronic device 11. When the electronic device 11 generates a test result during performing the boot test operation, the signal converter 12 converts the test result into a UART signal. When the UART adaptor 13 receives the UART signal from the signal converter 12, the UART adaptor 13 transmits it to the radio frequency unit 21.

The test control module 222 is further operable to convert each of the UART signals received into test information when the radio frequency unit 21 has received the UART signal from the UART adaptor 13. In one embodiment, the test information include the ID number of the workstation 1 and the test result of the electronic device 11 included in the workstation 1.

The result output module 223 is operable to display the test information of each of the electronic devices 11 on the display device 24, and to store the test information in the storage device 25.

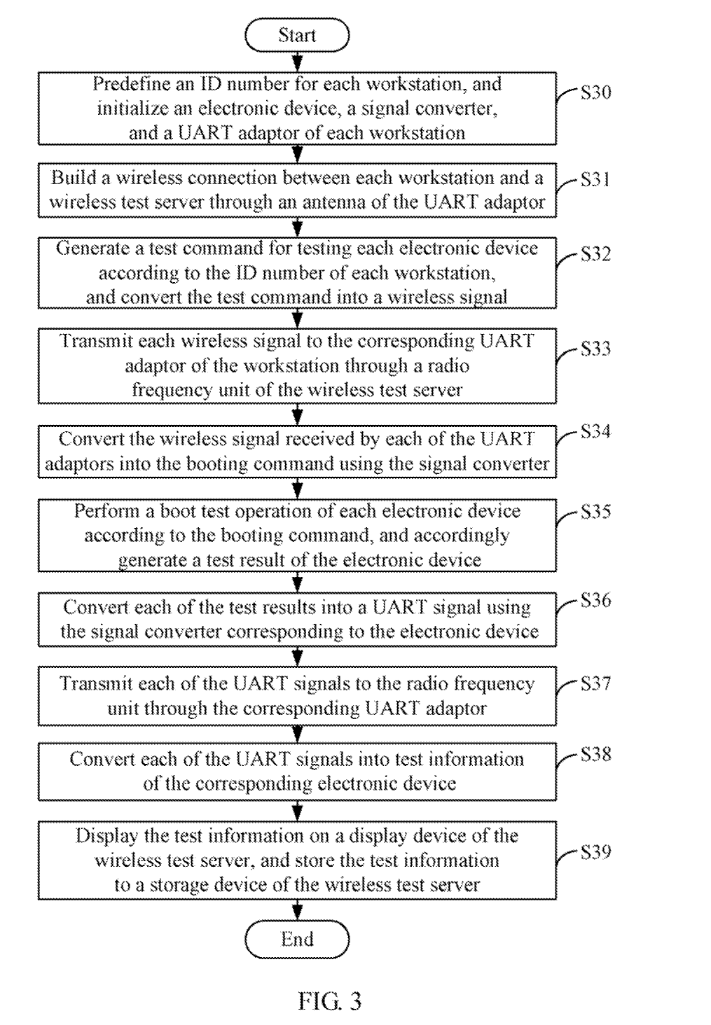

FIG. 3 is a flowchart of one embodiment of a method for testing electronic devices using the wireless test server 2 of FIG. 1. Depending on the embodiment, additional blocks may be added, others removed, and the ordering of the blocks may be changed.

In block S30, the wireless connection module 221 predefines an ID number for each of the workstations 1, and initializes the electronic device 11, the signal converter 12, and the UART adaptor 13 of the workstation 1.

In block S31, the wireless connection module 221 creates a wireless connection between each of the workstations 1 and the wireless test server 2. In one embodiment, the wireless connection module 221 controls the radio frequency unit 21 to connect to each of the UART adaptors 13 through its antenna. The radio frequency unit 21 identifies each of the UART adaptors 13 in creating a wireless connection according to the ID number of the workstation 1.

In block S32, the test control module 222 generates a test command for testing each of the electronic devices 11 according to the ID number of the workstation 1, and converts the test command into a wireless signal that can be transmitted over a wireless communication network, such as a radio frequency network.

In block S33, the test control module 222 controls the radio frequency unit 21 to transmit each wireless signal to the corresponding UART adaptor 13 according to the ID number of the workstation 1.

In block S34, the signal converter 12 converts the wireless signal into a booting command when the wireless signal is received, and sends the booting command to the electronic device 11.

In block S35, each of the electronic devices 11 performs a boot test operation to generate a test result according to the booting command, and sends the test result to the signal converter 12. In the embodiment, each of the electronic devices 11 executes a POST program to perform the boot test.

In block S36, the signal converter 12 converts the test result generated by the electronic device 11 into a UART signal and sends the UART signal to the UART adaptor 13. In block S37, the UART adaptor 13 transmits the UART signal to the radio frequency unit 21.

In block S38, the test control module 222 converts each of the UART signals into test information when the radio frequency unit 21 receives the UART signals from the UART adaptor 13. In one embodiment, the test information include the ID number of the workstation 1 and the test result of the electronic device 11 included in the workstation 1.

In block S39, the result output module 223 displays the test information of each of the electronic devices 11 on the display device 24, and stores the test information in the storage device 25.

All of the processes described above may be embodied in, and fully automated by means of , functional code modules executed by one or more general purpose processors of the computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A wireless test server, the wireless test server communicating with a plurality of workstations through a wireless communication network, the wireless test server comprising:
a radio frequency unit;
a storage system and at least one processor; and
one or more modules stored in the storage system and executable by the at least one processor, the one or more modules comprising:
a wireless connection module operable to predefine an ID number for each of the workstations, initialize an electronic device, a signal converter and a universal asynchronous receiver-transmitter (UART) adaptor of each of the workstations, and create a wireless connection between the wireless test server and each of the workstations; and
a test control module operable to generate a test command for testing each of the electronic devices according to the ID number of the workstation, convert the test commands into wireless signals, and transmit each of the wireless signals to the corresponding UART adaptor of the workstation through the radio frequency unit;
wherein each of the signal converters converts the wireless signal received by the UART adaptor into a booting command, and each of the electronic devices performs a boot test operation according to the booting command and accordingly generates a test result of the electronic device.

2. The wireless test server according to claim 1, wherein the signal converter converts the test result into a UART signal when the signal converter receives the test result from the electronic device.

3. The wireless test server according to claim 2, wherein the UART adaptor transmits the UART signal to the radio frequency unit through an antenna of the UART adaptor when the UART adaptor receives the UART signal from the signal converter.

4. The wireless test server according to claim 2, wherein the UART adaptor is a chipset that adapts to a ZigBee network protocol to transmit the UART signal through the wireless communication network.

5. The wireless test server according to claim 2, wherein the test control module is further operable to convert the UART signal into test information of the electronic device when the radio frequency unit receives the UART signal from the UART adaptor.

6. The wireless test server according to claim 5, further comprising a result output module operable to store the test information into the storage device, and display the test information on a display device of the wireless test server.

7. A method for testing electronic devices using a wireless test server, the wireless test server communicating with a plurality of workstations through a wireless communication network, the method comprising:
predefining an ID number for each of the workstations;
initializing an electronic device, a signal converter and a universal asynchronous receiver-transmitter (UART) adaptor of each of the workstations;
creating a wireless connection between the wireless test server and each of the workstations;
generating a test command for testing each of the electronic devices according to the ID number of the workstation, and converting the test commands into wireless signals;
transmitting each of the wireless signals to the corresponding UART adaptor of the workstation through a radio frequency unit of the wireless test server;
converting the wireless signal received by each of the UART adaptors into a booting command using the corresponding signal converter; and
performing a boot test operation of each of the electronic devices according to the booting command, and accordingly generating a test result of the electronic device.

8. The method according to claim 7, wherein the signal converter converts the test result into a UART signal when the signal converter receives the test result from the electronic device.

9. The method according to claim 8, wherein the UART adaptor transmits the UART signal to the radio frequency unit through an antenna of the UART adaptor when the UART adaptor receives the UART signal from the signal converter.

10. The method according to claim 8, wherein the UART adaptor is a chipset that adapts to a ZigBee network protocol to transmit the UART signal through the wireless communication network.

11. The method according to claim 8, further comprising:
converting the UART signal into a test information of the electronic device when the radio frequency unit receives the UART signal from the UART adaptor.

12. The method according to claim 11, further comprising:
storing the test information into a storage device of the wireless test server; and
displaying the test information on a display device of the wireless test server.

13. A non-transitory computer-readable medium having stored thereon instructions that, when executed by at least one processor of a server that communicates with a plurality of workstations through a wireless communication network, cause the server to perform a for testing electronic devices, the method comprising:
predefining an ID number for each of the workstations;
initializing an electronic device, a signal converter and a universal asynchronous receiver-transmitter (UART) adaptor of each of the workstations;
creating a wireless connection between the wireless test server and each of the workstations;
generating a test command for testing each of the electronic devices according to the ID number of the workstation, and converting the test commands into wireless signals;
transmitting each of the wireless signals to the corresponding UART adaptor of the workstation through a radio frequency unit of the wireless test server;
converting the wireless signal received by each of the UART adaptors into a booting command using the corresponding signal converter; and
performing a boot test operation of each of the electronic devices according to the booting command, and accordingly generating a test result of the electronic device.

14. The non-transitory computer-readable medium according to claim 13, wherein the signal converter converts the test result into a UART signal when the signal converter receives the test result from the electronic device.

15. The non-transitory computer-readable medium according to claim 14, wherein the UART adaptor transmits the UART signal to the radio frequency unit through an antenna of the UART adaptor when the UART adaptor receives the UART signal from the signal converter.

16. The non-transitory computer-readable medium according to claim 14, wherein the UART adaptor is a chipset that adapts to a ZigBee network protocol to transmit the UART signal through the wireless communication network.

17. The non-transitory computer-readable medium according to claim 14, wherein the method further comprises:
converting the UART signal into a test information of the electronic device when the radio frequency unit receives the UART signal from the UART adaptor.

18. The non-transitory computer-readable medium according to claim 17, wherein the method further comprises:
storing the test information into a storage device of the wireless test server; and
displaying the test information on a display device of the wireless test server.
